(19) United States
(12) Patent Application Publication
(10) Pub. No.: US 2013/0082637 A1
(43) Pub. Date: Apr. 4, 2013

(54) PORTABLE SOLAR PANEL POWER SOURCE

(71) Applicant: Day and Night Solar, LLC, Edwardsville, IL (US)

(72) Inventors: Robert G. Eaton, Edwardsville, IL (US); Kevin L. Schaller, Collinsville, IL (US)

(73) Assignee: Day and Night Solar, LLC, Edwardsville, IL (US)

(21) Appl. No.: 13/630,865

(22) Filed: Sep. 28, 2012

Related U.S. Application Data
(60) Provisional application No. 61/541,672, filed on Sep. 30, 2011.

(51) Int. Cl. F16M 11/18; H02J 7/00

(52) U.S. Cl. 320/101; 248/122.1

(57) ABSTRACT

An apparatus and method for portable solar panel assemblies configured to enable the unit to be transported by multiple means in order to provide both grid tied and off grid power as needed. Solar panel assemblies are configured to have a range of rotation of approximately 0 to 25 degrees in two directions to allow efficient sunlight capture. The solar panel assembly in the closed position will allow for more compact and aerodynamic profile when being transported.

### CROSS REFERENCE

This application claims priority to and the benefit of U.S. Provisional Patent Application Ser. No. 61/541,672 entitled PORTABLE SOLAR PANEL POWER SOURCE, Filed Sep. 30,2011, and is incorporated herein in its entirety.

### BACKGROUND OF INVENTION

1. Field of Invention

This invention relates generally to solar power and solar panels and, more particularly, to portable solar panels.

2. Background Art

The embodiments herein relate to solar panel assemblies configured so as to be relocated by multiple means, including but not limited to trailer, freight container, and air lifted. More specifically, the teachings herein can be used to charge banks of batteries, and/or used as portable power plants during emergencies and be fully deployed as full time grid tied power plant as well. It has become apparent in light of recent natural disasters, terrorist attacks and military deployments that power outages in areas of concern can happen suddenly. There is a need for emergency management responders and military personnel to have portable power plants that are self sustaining and reliable even under adverse conditions. Fossil fuels for engine based power generators are not always available. Also, a heavy transport means is not always available. Therefore, a stand alone, self sustaining system that can be easily transported is needed.

### BRIEF SUMMARY OF INVENTION

One implementation of the portable power system includes a solar panel assembly having multiple solar panels that are attached to hinged fan-folded panel frames. The panel frames have spring assisted hinges and are configured in an accordion type or fan-folded type configuration and secured to a rotating (pivoting) cradle assembly that is mounted to a single center pivot such that the cradle assembly rocks (rotates; pivots) on and about the center pivot.

The hinged fan-folded panels can be designed to expand laterally outward from the cradle assembly along and support by trusses that are laterally extendable from the cradle assembly. The truss can be retractable within the cradles assembly and extendable from the cradle assembly thereby supporting the panels as they are laterally expanded on top of the extended truss supports thereby configuring a cradle support frame and the cradle support frame can be designed with the center pivot such that the entire cradle support frame can rock (pivot) on the center pivot to thereby allow the angle of the panels to vary up to about +/−25 degrees off horizontal. The solar panel assembly can be mounted on a wheeled trailer (not shown) tor transport or placed on the bed of a truck or similar means of transport.

One implementation of the portable power station apparatus includes a rocker frame having spaced apart opposing vertically upright bearing frames substantially perpendicularly extending from the rocker frame on opposing distal end (sides) of the rocker frame, where the opposing vertically upright bearing frames each have respective opposing pivots. A cradle frame can be included having an extendable truss support member, where distal opposing ends of said cradle frame, are respectively pivotally mounted on opposing pivots to thereby allow the cradle frame to rock (pivot) on the pivots of the bearing frames. A plurality of fan-folded panel frames hingedly attached side-to-side each framing a plurality of solar panels can be mounted on the cradle frame, where said fan-folded panel frames are expandable to extend over the extendable truss support member when deployed.

These and other advantageous features of the present invention will be in part apparent and in part pointed out herein below.

### BRIEF DESCRIPTION OF THE DRAWINGS

For a better understanding of the present invention, reference may be made to the accompanying drawings in which;

FIG. 1 is a perspective of the solar panel assembly, in an unexpanded position;

FIG. 2 is a perspective of the solar panel assembly, trusses being extended;

FIG. 3 is a perspective of the solar panel assembly, solar panels being expanded;

FIG. 4 is a perspective of the solar panel assembly, solar panels in an expanded position with the solar panels pivoted off horizontal: and

FIG. 5 is a side elevation of the solar panel assembly with solar panels in an expanded position, with the solar panels pivoted off horizontal.

While the invention is susceptible to various modifications and alternative forms, specific embodiments thereof are shown by way of example in the drawings and will herein be described in detail. I should be noted that the drawing is not necessarily to actual scale and proportion, however clearly illustrates the various aspects of the various embodiments of the invention. It should also be understood, however, that the drawings and detailed description presented herein are not intended to limit the invention to the particular embodiment disclosed, but on the contrary, the intention is to cover all modifications, equivalents, and alternatives falling within the spirit and scone of the present invention as defined by the appended claims as would be apparent to persons skilled in the art area.

### DETAILED DESCRIPTION OF INVENTION

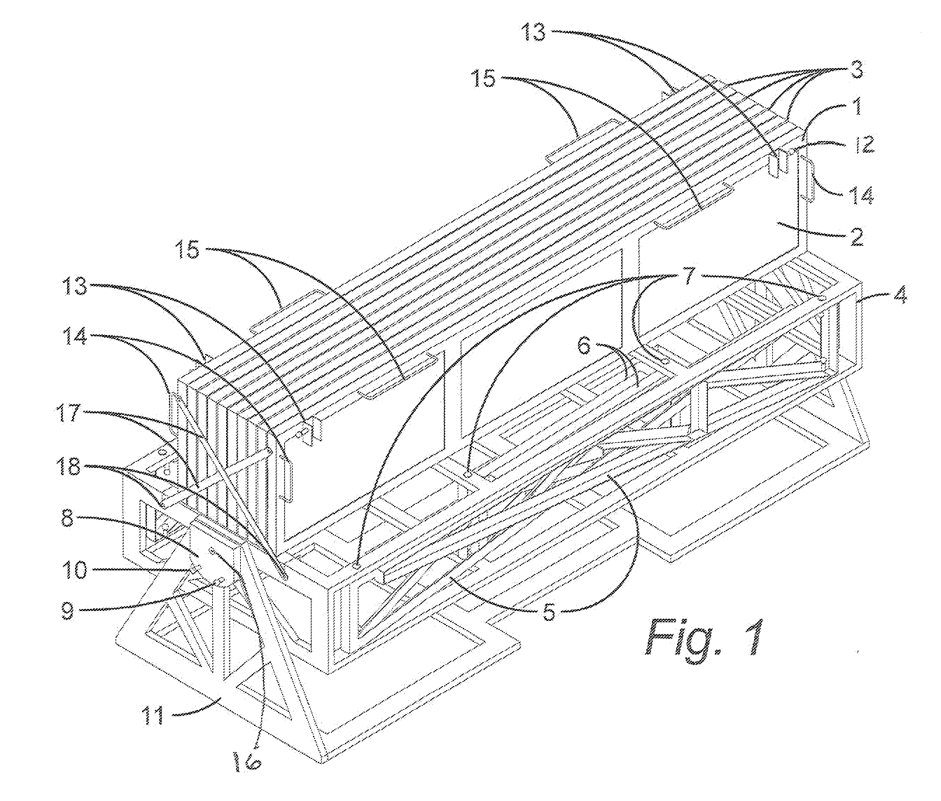

According to the embodiment(s) of the present invention, various views are illustrated in FIGS. 1-5 and like reference numerals are being used consistently throughout to refer to like and corresponding parts of the invention for all of the various views and figures of the drawing. Also, please note that the first digit(s) of the reference number for a given item or part of the invention should correspond to the Fig. number in which the item or part is first identified.

One implementation of the portable power system, having a deployable fan folded solar panel teaches a novel apparatus and method for providing a portable solar powered power source. The details of the invention and various embodiments can be better understood by referring to the figures of the drawing. Referring to FIG. 1, a complete solar panel assembly having hinged fan-folded panel frames (1) containing solar panels in the closed position is shown. The hinged fan-folded panel frames (1) hold the solar panels (2) and can be designed to expand outward along supporting retractable trusses by engaging a u-shaped mounting track of the panel frames with the trusses, which expand out from the cradle assembly (4). The legs of the u-shaped mounting track (u-shaped bracket) can straddle on either side of the truss to thereby align the movement of the panels as they extend and restrict lateral movement of the panels as they are extended. The hinges can be spring assisted for ease of extending and ease of retraction. The main support frame or rocker frame (11) can be designed with a center pivot point or fulcrum to allow the panel frames and solar panels to vary in angle off horizontal when the panels are extended. The assembly can be designed to allow for a variance in angle of up to about +/−25 degrees off horizontal. The multiple panel frames (1) can be hingedly attached side-to-side and retracted in a fan-folded manner using spring assisted hinges (3) to assist expanding and retracting the panel frames. When in the folded position, support straps (17) can be attached between support pins (18) to stabilise the assembly. The cradle assembly (4) or the main support frame can include inner trusses (6) and outer trusses (5) as shown in the retracted position. When deployed, the trusses can swing outward pivoting around pivot pin (7) from the cradle assembly for operational support of the extended solar panels.

When the trusses (5) and (6) are deployed, the outer most panel frames can be un-folded or the top most side of the outer most panel frame can be rotated outward and downward to a flat position against the supporting trusses and thereby engaging the u-shaped bracket (13). The side handles (14) and the horizontal handles (15) can be grasped and utilized to expand and stow the panel frames. The opposing legs of the u-shaped bracket (13) can be aligned on either side of the top alignment bar of the outer trusses such that the panel frames can track along the trusses as they are being expanded. The u-shaped bracket (13) can track along the top alignment bar of the outer trusses. The legs of the u-shaped bracket can resist or prevent lateral movement of the panels. The u-shaped brackets can include channel spring pins (12), which can he retracted to allow the u-shaped bracket to engage the outer trusses and then released to engage a lengthwise groove or recess on the side of the top alignment bar of the outer trusses to thereby lock the panel in place.

The cradle assembly (4) can be pivotally mounted on a supporting rocker frame (11) having opposing upright bearing frames on opposing sides of the rocker frame such that opposing sides of the cradle assembly each are pivotally mounted at opposing pivot points or fulcrums of the opposing upright bearing frames of the rocker frame. The pivot points on which the cradle assembly is mounted can be pivot point plus or bearings (16) or the pivot points can be created by pivot rod that extends between opposing fulcrums of the opposing upright bearing frames. The spring pin and safety bolt can be released to allow the cradle assembly to pivot or “see-saw” about the fulcrum or pivot point. The cradle can then act as a lever to tilt the cradle up or down to approximately +/−25 degrees off horizontal. The support plate (8) can be added for additional strength. Another implementation, not shown,, could include a center rocker frame or center upright stand having a pivot point or fulcrum centered on the cradle assembly and where the center rocker frame is centered under the cradle assemble, similar to the design of a “see-saw”.

The solar panel assembly can be mounted on a wheeled trailer (not shown) for transport or placed on the bed of a truck or similar means of transport the assembly can also be placed in a standard 20′×10′×10′ container and transported to a location where the assembly can be mounted to a more permanent structure. Once in position and operational the solar panel assemble can operate as an on-grid and off-grid power source. One embodiment of the system, allows multiple systems to be daisy chained together. One embodiment of the assembly can include a bank of batteries the can be charged by the solar cells. An operational system can provide 7500 watts of power. Yet another embodiment can include a backup power source such as a combustion engine. The assembly can also include military grade fused link faraday boxes such that the system is electromagnetic pulse resistant.

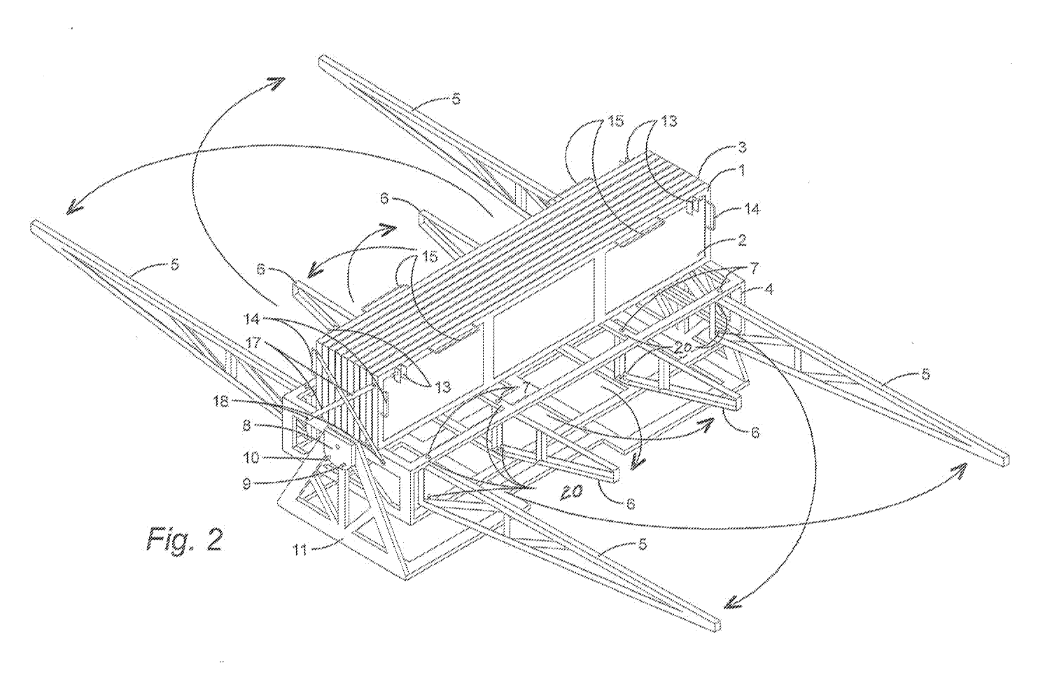

Referring to FIG. 2, the trusses (5) and (6) are illustrated as being opened (extended outward from the cradle assembly) in order to support the solar panels from underneath. Each truss (5) and (6) can be mounted to the main support frame with a hinge or a pivot mount. In the embodiment shown, the trusses are released by the spring pin (20) and rotated from a stowed position within the main frame or flush against the frame, out away from the main frame (as indicated by the arrows) on pivot rods (7) to an orientation substantially perpendicular to the main frame to an open position. Once the trusses (5) and (6) are in the open position, the spring pin (20) can be released locking the truss in position. The spring pin (20) locates and holds the truss (5) and (6) in the proper location. The straps (17) can be removed and the handles (14) and (15) can be grasped to pull the top ends of the outer most panel frames downward to engage the u-shaped brackets (13) with the outer trusses (5). This process can he repeated for each of the trusses and on either side of the main frame.

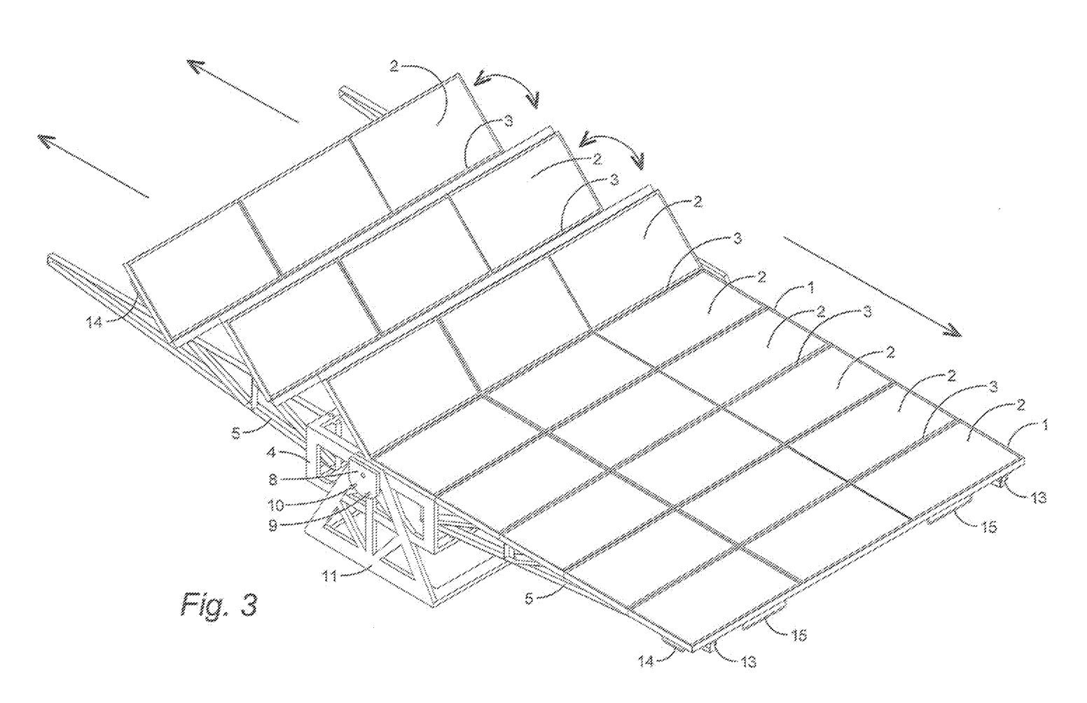

Referring to FIG. 3, the solar panels (2) are mounted in the panel frames (1) and the panels are hinged in an accordion or fan-folded type configuration. This allows the panel frames (1) to be opened (extended) and closed (retracted). To open, release one side of the support strap (17) (FIG. 2), pull handles (14) and (15) mounted to the panel frames (1) into the open position. The spring actuated assist binges (3) helps to eliminate any unwanted movement. Also, the spring actuated assist hinge (3) assists in the opening and closing of the panels frames (1). Once open, use the u-shaped bracket's spring pin (12) to lock in place. The process is repeated on opposite side. The u-shaped bracket (13) in this view is shown engaged with the top bar of the outer trusses. The cradle assembly (4) in this view is shown in a substantially horizontal orientation.

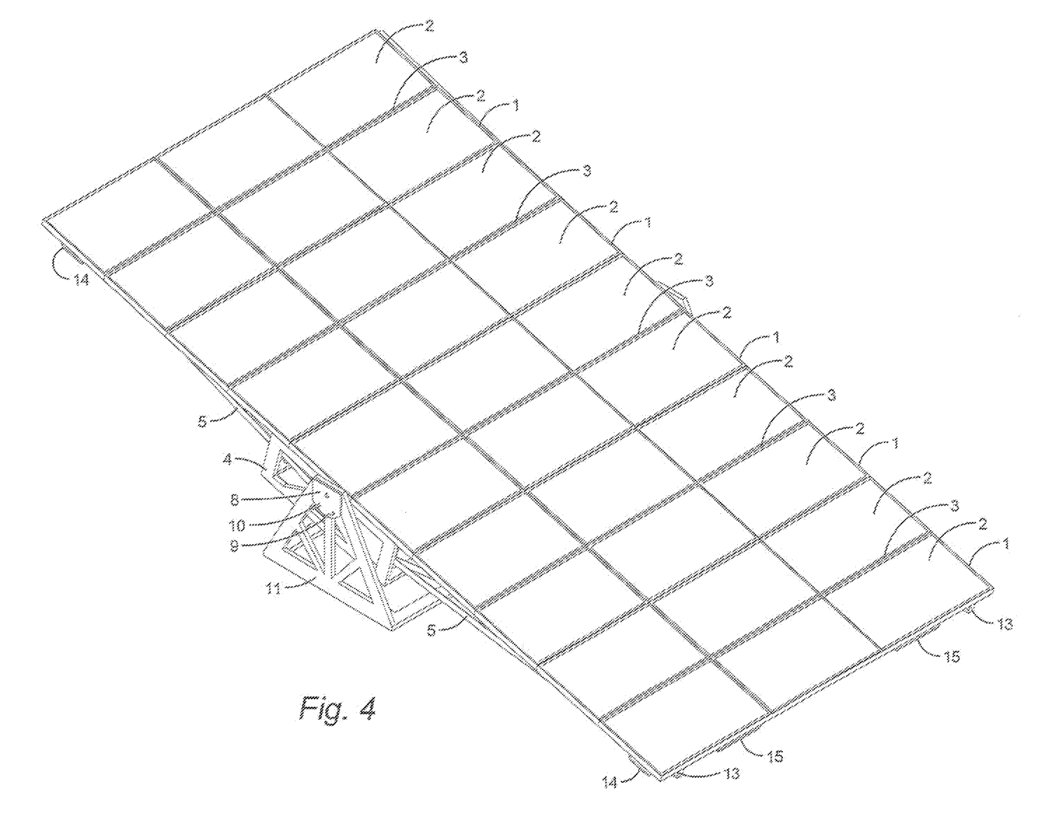

Referring to FIG. 4, the assembly is shown with panels and supporting trusses fully expanded and the cradle in this view is shown with a slight tilt (angle) off horizontal. The cradle assembly and frame panels have been tilted or pivoted about the pivot point (fulcrum) (8) of the rocker frame (11).

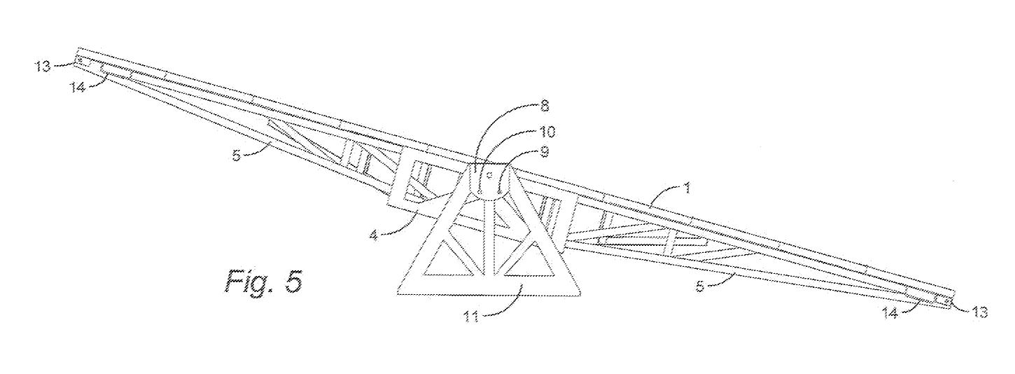

Referring to FIG. 5, after unit is fully expanded, the safety holt (10) can be removed, and the spring pin (9) located on the rocker frame (11) can be pulled and released. The rocker frame's fulcrum (pivot point) can allow the cradle assembly (4) to “see-saw” or pivot (rock) on the pivot thereby allowing either opposing side of the cradle assembly to tilt up or down to about +/−25 degrees off horizontal left or right, the locater holes on the support plate (8) for proper positioning. The spring pin (9) can he released and locked into place with the safety bolt (10).

In order to stow the assembly the cradle (4) can be pivoted back into the horizontal flat position. The safety bolt (10) can be removed, the spring pin (9) located on the rocker frame (11) can be pulled and released. The channel spring pins (12) of the u-shaped bracket (13) that holds the panels to the truss can be pulled and released. By lifting up using the handles (14) and (15) and sliding the panels into the closed position, the panels can be returned to the stowed fan-folded position. Once closed, one side of the support strap (17) (FIG. 2) can be attached. This can he repeated on opposite side.

In order to close trusses (5) and (6) the spring pin (20) can be pulled and released to fold the truss into the cradle (4) returning it to the stowed position. The trusses (5) and (6) can now be secured in the cradle (4) during transporting.

When deploying the solar panel assembly, a user can always position the unit so that when it is opened it will face north and south. Once open, it can rotate either direction, ensuring that the unit will always face south.

The various portable solar panel assembly examples shown above illustrate various embodiments of a novel portable solar panel assembly design. A user of the present invention may choose any of the above implementations, or an equivalent thereof, depending upon the desired application. In this regard, it is recognized that various forms of the subject solar panel assembly design could be utilized without departing from the spirit and scope of the present invention.

As is evident from the foregoing description, certain aspects of the present invention are not limited by the particular details of the examples illustrated herein, and it is therefore contemplated that other modifications and applications, or equivalents thereof, will occur to those skilled in the art. It is accordingly intended that the claims shall cover all such modifications and applications that do not depart from the sprit and scope of the present invention.

Other aspects, objects and advantages of the present invention can be obtained from a study of the drawings, the disclosure and the appended claims.

What is claimed is:

1. A portable power station comprising:
a rocker frame having spaced apart opposing vertically upright bearing frames extending from the rocker frame on opposing distal sides of the rocker frame, where the opposing vertically upright bearing frames each have respective opposing pivots;
a cradle frame having an extendable truss support member, where distal opposing ends of said cradle frame are respectively pivotally mounted on opposing pivots; and
a plurality of fan-foldable panel, frames hingedly attached side-to-side each framing one of a plurality of solar panels and slidably mounted on the cradle frame, where said fan-folded panel frames are expandable to extend over the extendable truss support member when extended.

2. The portable power station as recited in claim 1, further comprising;
a battery bank electrically coupled to the plurality of solar panels and operable to be electrically charged by said solar panels.

3. The portable power station as recited in claim 1, where the plurality of fan-folded panel frames includes an outer most panel frame where said outermost panel frame has a u-shaped bracket to aligned, straddle and engage the extendable truss support member.

4. The portable power station as recited in claim 1, where the cradle frame pivotally mounted on opposing pivots can pivot on either side of the pivot up or down up to about +/−25 degrees off horizontal.

5. A method for deploying a portable power station comprising the steps of:
deploying a rocker frame and cradle assembly having a plurality of expandable fan-foldable hingedly attached side-to-side solar panels, where the rocker frame has spaced apart opposing vertically upright bearing frames extending from the rocker frame on opposing distal sides of the rocker frame, where the opposing vertically upright bearing frames each have respective opposing pivots;
pivoting the cradle frame on the opposing pivots, where distal opposing ends of said cradle frame are respectively pivotally mounted on opposing pivots;
extending an extendable truss support member from the cradle frame; and
expanding the plurality of fan-foldable panel frames hingedly attached side-to-side each framing one of a plurality of solar panels and slidably mounted on the cradle frame, where said fan-folded panel frames are expandable to extend over the extendable truss support member when extended thereby supporting the panels with the truss support member.

6. The method for deploying the portable power station as recited in claim 5, further comprising the steps of:
charging electrically a battery bank electrically coupled to the plurality of solar panels when said solar panels are exposed to solar energy.

7. The method for deploying the portable power station as recited in claim 5, where the plurality of fan-folded panel frames includes an outer most panel frame whom said outermost panel frame has a u-shaped bracket to aligned, straddle and engage the extendable truss support member further comprising the step of slidably engaging the u-shaped bracket with the truss support member wiser; expanding the plurality of fan-foldable panels.

8. The method for deploying the portable power station as recited in Claim 5, further comprising the step of:
pivoting the cradle frame up or down over a range of up to about +/−25 degrees off horizontal where said cradle frame is pivotally mounted on opposing pivots and is operable to pivot on either side of the pivot up or down.
